(19) United States
(12) Patent Application Publication
(10) Pub. No.: US 2026/0220507 A1
(43) Pub. Date: Jul. 30, 2026

(54) HYPER-DIMENSIONAL AND HYPER-SPHERICAL GRAPHICAL MODELS

(71) Applicant: William D. Richards, Las Vegas, NV (US)

(72) Inventor: William D. Richards, Las Vegas, NV (US)

(21) Appl. No.: 19/444,735

(22) Filed: Jan. 9, 2026

Related U.S. Application Data
(60) Provisional application No. 63/749,184, filed on Jan. 24, 2025.

(51) Int. Cl. G06N 7/01

(52) U.S. Cl. CPC G06N 7/01

(57) ABSTRACT

Partial input data corresponding to a subset of variables of a data sample are embedded into a variable space of a probabilistic graphical model containing a plurality of transformation invariant components. Variational parameters associated with one or more latent variables of the probabilistic graphical model are determined by optimizing a probabilistic objective reflecting likelihood of the partial input data by adjusting variational parameters governing the probability distribution over latent variables in the probabilistic graphical model. Latent variable values are sampled from a posterior distribution defined by the variational parameters. Output data is generated by converting the sampled latent variables into output data corresponding to an application domain.

### CROSS REFERENCE TO OTHER APPLICATIONS

This application claims priority to U.S. Provisional Patent Application No. 63/749,184 entitled HYPER-DIMENSIONAL AND HYPER-SPHERICAL GRAPHICAL MODELS filed Jan. 24, 2025 which is incorporated herein by reference for all purposes.

### BACKGROUND OF THE INVENTION

Recent advances in machine learning have led to the development of large-scale neural network architectures for a wide range of generative tasks, such as text generation, image synthesis, and video generation. Such architectures typically rely on deep, feed-forward or attention-based networks that implicitly encode both a probabilistic model of observed data and an associated inference process over internal hidden representations. As model capacity and task complexity increase, these approaches require substantial computational resources, memory, and training data, which can limit their practicality in resource-constrained or latency-sensitive environments.

Probabilistic graphical models, by contrast, explicitly represent latent variables and their conditional dependencies, enabling structured reasoning and interpretability. However, in high-dimensional settings, accurate posterior inference over latent variables often becomes computationally intractable, particularly as the number of variables and interactions increases. As a result, existing graphical-model based generative techniques have encountered significant scalability challenges and have been difficult to apply effectively to large, complex data domains such as high-resolution image generation and large-scale language modeling.

### BRIEF DESCRIPTION OF THE DRAWINGS

Various embodiments of the invention are disclosed in the following detailed description and the accompanying drawings.

FIG. 1 illustrates an example probabilistic graphical model.

FIG. 2 shows a flow diagram of an example process for generating a sample from a hyper-dimensional neural network in accordance with some embodiments.

FIG. 3 shows a flow diagram schematic for an example training procedure for determining the weights of a hyperdimensional graphical model in accordance with some embodiments.

FIG. 4 is a block diagram illustrating a system to generate output samples conditioned on partial inputs using a probabilistic graphical model in accordance with some embodiments.

FIG. 5 is a flow diagram illustrating a process to generate output samples conditioned on partially specified input data using a probabilistic graphical model in accordance with some embodiments.

FIG. 6 illustrates an example data flow within a graphical model system configured to generate output data samples conditioned on partially specified input data, in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

The techniques described herein may be implemented using one or more computing devices that are communicatively coupled over a network, such that different portions of the techniques are performed by different devices. For example, operations may be performed by client devices, servers, cloud computing platforms, edge devices, gateways, or any combination thereof, and data and/or control signals may be exchanged between such devices via wired or wireless communication links. Accordingly, the techniques may be implemented in distributed, client-server, cloud-based, edge-based, or hybrid computing environments, and references to a “system,” “apparatus,” or “processor” encompass collections of network-connected devices that cooperatively perform the disclosed operations.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Aspects of this disclosure relate generally to probabilistic graphical models (PGMs), generative neural networks, and hybrid generative modeling techniques. Such models are commonly trained to learn a probability distribution over observed data by maximizing the likelihood of a training dataset or an similar objective, in some cases taking into account auxiliary objectives, including for example being more preferable to human annotators.

In many implementations, training is performed by minimizing a divergence between a distribution of generated samples and an underlying data distribution. For latent-variable models, this often involves estimating a posterior distribution over latent variables and optimizing the evidence lower bound (ELBO) of the data log likelihood.

For larger models, optimization is often expressed as maximization of the ELBO, which may be written as:

$${ℒ}_{θ , ψ} ( x ) = {𝔼}_{z ∼ {q}_{ψ} ( z \vert x )} [ log ( \frac{{p}_{θ} ( x , z )}{{q}_{ψ} ( z \vert x )} ) ]$$

Evaluation of this quantity requires knowledge of the posterior distribution q_{ψ}(z|x) of the latent variables z given observed data x. If the posterior q_{ψ}(z|x) is exact, the ELBO [symbol] _{θ,ψ}(x) corresponds to the true log likelihood of the data. However, for large or high-dimensional models, exact computation for this posterior is generally intractable.

As a result, practical implementations typically employ approximate posterior distributions, often using variational approximations with restricted functional forms. In such cases, the ELBO serves as a lower bound on the true likelihood. Objective functions may also be augmented with additional terms to encourage specific properties of the trained model, such as sparsity, smoothness, or stability, or may be replaced entirely by alternative surrogate objectives.

Training of PGMs, as well as inference for tasks, such as marginalization or classification, requires calculation of or sampling from the posterior distribution q(z|x) given a data point x. Model parameters θ may then be optimized to maximize the likelihood of training data using gradient descent or other methods, such as contrastive divergence.

Sigmoid belief networks are one class of PGMs that have received significant attention in attempts to scale graphical models to greater size and complexity. These models consist of layers of stochastic binary variables connected by weighted interactions. While sampling from such models is relatively straightforward, exact computation of the posterior distribution q(z|x) becomes intractable as model size increases, with computational complexity scaling exponentially with the number of variables.

Even when variational inference methods are employed, sigmoid belief networks and related models have proven difficult to optimize at scale, severely limiting their depth and resolution. As a result, such models have not been effectively applied to high-dimensional tasks, such as high-resolution image generation or large-scale language modeling.

Variational Autoencoders represent an approach that bridges PGMs and neural networks by parameterizing the generative process as a neural network transformation of samples from a simpler latent probability distribution. A recognition model q_{φ}(z|x), also parameterized by a neural network with weights φ, is trained to approximate the posterior distribution over latent variables.

VAEs are trained by optimizing the ELBO through back-propagation of gradients through both the generative network and the recognition network. While this approach enables scalable training parameterization of the recognition model by a neural network limits flexibility. In particular, adapting the model to variations, such as partially missing data, alternative conditioning variables, or inference tasks such as classification or inpainting may require retraining or architectural modification.

Neural networks more generally have been scaled to increasingly large parameter counts and applied successfully across a diverse range of high-dimensional generative tasks. In such feed-forward models, the network parameters implicitly encode both a probabilistic model of the data and the inference procedure used to map inputs to outputs. As a consequence, a significant portion of the representative capacity of large neural networks may be devoted to learning inference behavior itself, in addition to modeling the data distribution. This contributes to increased computational cost, memory requirements, and training data demands as models size and task complexity grow.

In contrast, PGMs explicitly represent latent variables and their interactions, enabling structured reasoning and flexible conditioning. However, the computational cost of calculating or approximating posterior distributions in conventional PGMs has limited their scalability relative to neural-network-based approaches. Accordingly, existing PGM-based generative techniques have encountered significant challenges when applied to large, structured, or high-dimensional datasets, in part due to the potentially exponential scaling behavior of posterior inference with respect to the number of latent variables.

The systems and methods described herein provide PGMs that address these limitations by enabling efficient posterior inference in complex, high-dimensional latent spaces. In some embodiments, structured high-dimensional latent variables and interaction functions that permit posterior distributions or variational approximations thereof to be computed efficiently are employed, without reliance on a separate neural-network-based recognition model.

The disclosed systems and methods generate output data conditioned on partially specified input data using a PGM. Rather than requiring complete input samples, the system operates on arbitrary subsets of observed variables and infers missing or unobserved components in a probabilistically consistent manner.

Observed input data is incorporated directly into the variable space of the PGM, thereby conditioning the model on known values while leaving other variables unspecified. Variational parameters associated with latent variables are then determined through an optimization process that reflects the likelihood of the observed data under the learned model. Based on these parameters, a posterior distribution over latent variables is formed, capturing uncertainty associated with unobserved portions of the data.

The system generates output samples by sampling latent and output variables from the posterior distribution and converting the sampled representations into application-specific output forms. This approach enables flexible generation, prediction, completion, or classification of data across a wide range of domains, including images, text, audio, time-series data, and multimodal inputs, without requiring retraining when different subsets of input variables are provided. The disclosed techniques support scalable inference in high-dimensional latent spaces while maintaining consistency with partially specified inputs.

In some embodiments, posterior inference is performed using optimization procedures that scale polynomially rather than exponentially with model size, thereby enabling substantially larger graphical models than previously practical. This improvement in posterior inference scalability enables the training and deployment of deeper and more expressive latent-variable models, improving the quality of generated samples and inferred distributions, and expanding applicability to high-dimensional generative tasks.

Moreover, because posterior parameters may be determined through direct optimization rather than through a fixed feed-forward recognition network, embodiments described herein provide increased flexibility after training, including the ability to condition on arbitrary subsets of variables or to perform marginalization without retraining model parameters. Such flexibility enables efficient reuse of a trained PGM for multiple inference tasks, including conditional generation, classification, inpainting, and anomaly detection, using the learned parameters. Accordingly, the disclosed systems and methods bridge advantages of PGMs and large-scale neural networks by providing scalable generative modeling with efficient inference, flexible conditioning, and applicability to complex, high-dimensional data domains.

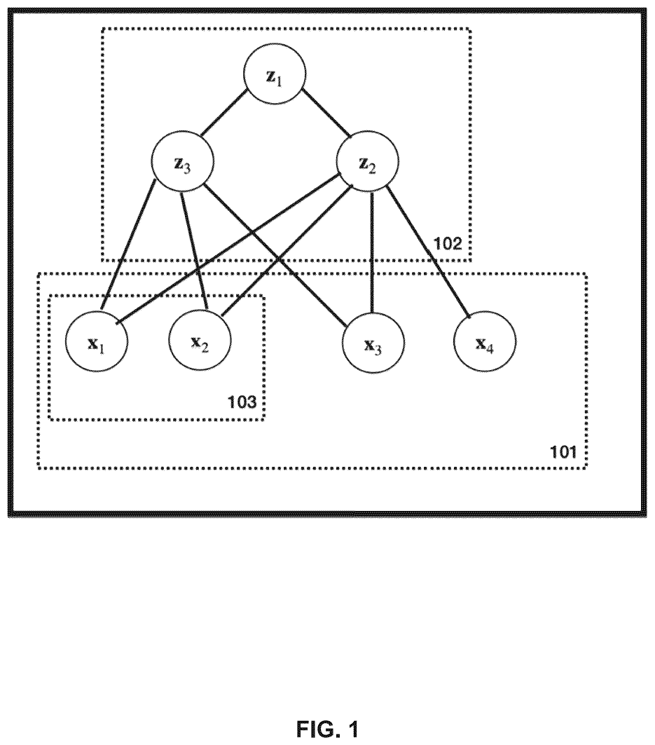

FIG. 1 shows a schematic of an example probabilistic graphical model with interactions between a set of observable variables 101 and latent variables 102. The interactions between variables may be directed (as in belief networks), undirected (as in Markov random fields), factors (as in factor graphs) or a mixture of various interaction types. Conditioning variables may be selected from either variables 101 or 102. Variables 103 are observed, conditioning variables. The subset 103 of variables over which the model is conditioned on is arbitrary, and may vary between particular data points during training and during conditional sampling.

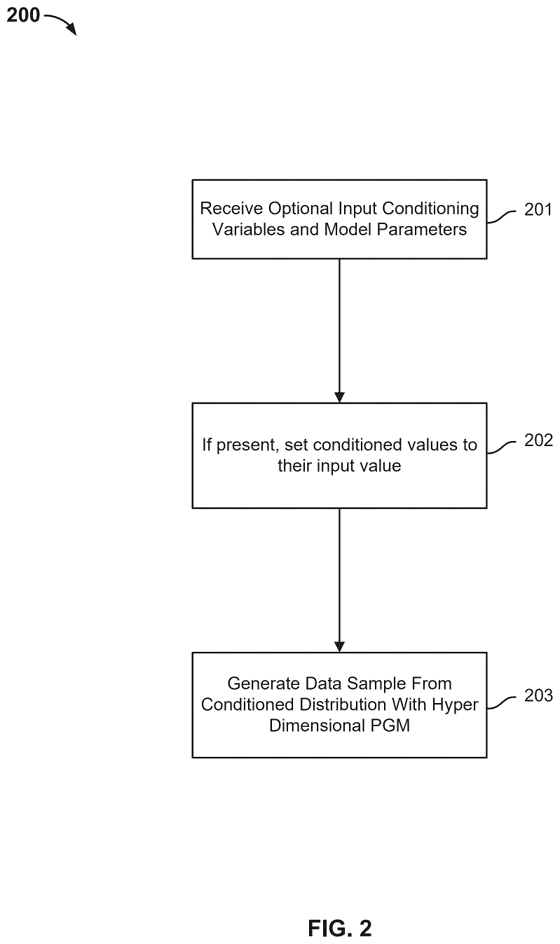

FIG. 2 shows a flow diagram of an example process 200 for generating a sample from a hyper-dimensional neural network in accordance with some embodiments. The system receives a specified set of weights (which may be the result of a training procedure 300), as well as optionally a set of conditioning values for a subset of variables 103 (step 201). For each conditioning variable supplied, the system sets the value of its corresponding variable from 101 to the supplied value (step 202). It then generates a sample comprising values for each of the remaining variables in 101 and 102 (step 203). The generation process may be any process for generating samples from PGMs, such as Markov chain Monte Carlo, Gibbs sampling, hierarchical sampling, etc., provided that the probability function is consistent with the description in this specification. The system may also generate a distribution over the remaining variables corresponding to the input values.

For example, the system may be a machine translation system, whereby the variables 101 may be a plurality of sequences of words of a plurality of languages. In such a system, the output may comprise a sequence of words in a target language, conditioned on a sequence of words in an original language (variables 103).

As another example, the system may be a speech recognition or generation system, where a subset of variables 101 represent audio data and another subset of variables 101 represent graphemes, words, or other characteristics corresponding to the audio data. To be configured as a speech recognition system, it may generate sample graphemes or word sequences conditioned on the audio data, in which case variables 103 represent audio data. To be configured as a speech generation system, it may generate audio data conditioned on the graphemes or word sequences, in which case variables 103 represent graphemes or word sequences.

As another example, the system may be an image recognition or generation system, where a subset of variables 101 represent the pixels in an image, and another subset of variables 101 represents the contents of the image, for example a written description of the image or the location and classification of various objects within the image. The system may be configured to generate images conditioned on a description of the image (variables 103), or to generate descriptions of the contents of an image, conditioned on the image itself (variables 103). The system may also be configured to receive a partial image (variables 103), and output samples of the full image (variables 101), and may or may not be conditioned on an image description (variables 103).

As another example, the system may be a time series modeling system that is robust to missing input data, for example it may be used to predict missing or future data or stock prices in a financial model. In such an example, variables 101 may represent financial data or stock prices, and process 200 produces distributions over any missing data in the conditioning input data (variables 103, step 201).

As another example, the system may be a language modeling system which may be configured to complete sentences, interact with a user of the system via chat, or output larger bodies of text or media by generating output sequences conditioned on a text input sequence. In such a system, variables 101 may represent sentences, sequences of interactions with a user, or pairs of input prompts and output text or media respectively.

As another example, the system may be a recommendation engine, with the system trained on user data and preferences, and producing as output samples from or distributions over a user's expected rating for a website or other piece of content. In such a system, variables 101 may represent triplets of user data, content, and ratings, with variables 103 representing the user data and content.

As another example, the system may be an outlier or anomaly detection system, with the system trained on typical examples from a data distribution, and outputting the ELBO or probability of a given input sample.

As another example, the system may be an unsupervised embedding system, where variables 101 may represent high dimensional data, and the variables 102 a lower-dimensional representation.

The variables 101 may represent any encoding of the data, as well as the data itself. For example, they may be formed from a principal component analysis dimensionality reduction of the data, a binary encoding of the data, or the outputs of a neural network encoder.

In particular, hyperdimensional PGMs allow scaling of latent-variable models to high-dimensional structured latent spaces using a specific form of p_{θ}(x, z) so that the posterior distribution q_{ψ}_{ₓ}(z|x) or a variational approximation to it may be determined more efficiently by optimization of the marginalized likelihood p_{θ}(x) or surrogate objective. This optimization may be performed by gradient descent, Gibbs sampling, or any other method. This optimization does not need to find the global minimum or converge exactly to a local minimum—approximate solutions are sufficient in many embodiments.

This specification uses the notation q_{ψ}_{ₓ}(z|x) for the posterior to distinguish that the variational parameters ψ are per-example, and are not parameterizing a (global) neural network, as in the case variational auto encoders q_{φ}(x|z).

Thus, hyperdimensional PGMs may compute variational parameters directly by optimization of:

$${ψ}_{x} = {arg max}_{ψ} {𝔼}_{z ∼ {q}_{ψ} ( z \vert x )} [ log ( \frac{{p}_{θ} ( x , z )}{{q}_{ψ} ( z \vert x )} ) ] \qquad ( 1 )$$

This optimization can be made computationally feasible by constructing the objective function such that it contains a plurality of invariant components. An invariant component can be broadly defined to be an intermediate value obtained during the computation of the objective that is invariant to a group of transformations of its inputs. In many embodiments, this invariance is clearly apparent from the form of the conditional probability distributions employed by the model as well as the factorization of the variational posterior approximation, but in others it is more nuanced.

The calculation of the objective function can be broken down into a number of intermediate component functions ƒ_{c}(ψ), which are computed and combined, for example, in some embodiments by summation of components of the ELBO

$$L ( ψ ) = {\sum }_{c = 0}^{m} {f}_{c} ( ψ ) {f}_{c} ( ψ ) = {E}_{z ∼ {q}_{ψ} ( z )} [ log \frac{p ( {z}_{i} \vert {z}_{: i} )}{{q}_{ψ} ( {z}_{i} )} ]$$

A component ƒ_{c}(ψ) is considered to be invariant if there exists a continuous group of mappings T∈G that operates on w/without changing the resulting value, i.e.

$${f}_{c} ( ψ ) = {f}_{c} ( T ( ψ ) ) ∀ ψ , T ∈ G$$

In some embodiments, a plurality of components, particularly those between only latent variables, are invariant the same group of mappings G.

In some embodiments, Hyperdimensional PGMs construct p_{θ}(x, z) and q_{ψ}_{ₓ}(z|x) such that the interactions between latent variables (102) are (at least approximately) invariant to a transformation of each latent variable by any transformation T within a continuous group of such transformations [symbol] . When considering graphical model structures with the data as leaf nodes with directed edges leading to them, p_{θ}(x, z) may be factorized as the product of a conditional probability function g_{θ}(x|z), individual latent variable bias terms ρᵢ(zᵢ), and an interaction function ƒ_{θ}(z), i.e. that p_{θ}(x, z)=g_{θ}(x|z)ƒ_{θ}(z)Πᵢρᵢ(zᵢ), with ƒ_{θ}(z)≈ƒ_{θ}(T(z))∀z, T∈

[symbol]

Note that in some embodiments, the distribution over latent variables may be conditional on x, and so will have different overall factorization, but similar transformation-invariance the latent-variable interaction term ƒ_{θ}(z). In some embodiments, the bias terms ρᵢ(zᵢ) may be uniformly distributed and thus not necessarily explicitly included in the formulation.

In many embodiments, these transformations are elements of the special orthogonal group SO(N), and the probability function p is constructed relatively simply by being functions of dot-products between variables, such as p(zᵢ|z)=ƒ(zᵢₖzⱼₖ) (using Einstein summation notation).

This is of course not the only way to construct a component with the necessary invariance. Consider the simple model with 2 latent variables, parameterized by an arbitrary matrix A

$$p ( {z}_{1} , {z}_{2} ) ∝ exp ( - {z}_{1}^{τ} A {z}_{2} )$$

This is generally not invariant to transformation of both z₁ and z₂ by the same element of SO(N), but p is invariant to a transformation that maps

$${z}_{1}^{′} = {( {A}^{- 1} )}^{τ} {BA}^{τ} {z}_{1} , and {z}_{2}^{′} = {Bz}_{2} ,$$

for any B that is an element of SO(N), leaving N−1 degrees of freedom in specifying z₁ and z₂.

The described transformation invariance ensures that degrees of freedom exist in the optimization of (1), allowing separate optimization of relationships between interacting variables and between entire neighborhoods of variables. These additional degrees of freedom reduce the propensity for the optimization over the posterior parameters ψ to get stuck in a local minimum, improving the quality of the posterior estimate from (1) and allowing use of much larger graphical models with many more parameters. The combination of improved posterior estimates and larger model size ultimately results in improvements to the quality of generated samples and posterior distribution estimates.

In some embodiments, the ELBO or surrogate optimization objective, rather than the probability function, obeys this invariance. In some embodiments, each term in the factorization of ƒ_{θ}(z) obeys such an invariance.

Despite the clear improvements to the performance of gradient descent optimization of the posterior in Hyperdimensional PGMs, they are not restricted to use of gradient descent methods; sampling and other methods also benefit from improved performance via the reduction in number and severity of local minima. For the case of sampling and Monte Carlo methods this results in achieving equilibrium or ergodicity with fewer sampling steps.

Hyperdimensional PGMs may be homogenous, in that the entire network obeys such an invariance, or inhomogeneous, with different factors in the probability distribution obeying different forms of transformation invariance, or even differing dimensionality of variables.

As with other neural networks, hyperdimensional PGMs also require that the probability functions within hyperdimensional neural networks have nonlinear components. Note that this nonlinearity may be achieved through nonlinearities in the interactions between variables, or as a consequence of restrictions in variable domain—for example the nonlinearity of a sigmoid function arises from linear energy interactions but a restricted domain of {0, 1} or {−1, 1} depending on the parameterization. This distinguishes them from for example, factorized gaussian linear models, and allows them to capture more complex data distributions.

The requirement that T is an element of a non-degenerate continuous space of transformations excludes sigmoid belief networks from this definition; though the transformation ƒ(z)=−z preserves probabilities, the space of these transformations is nil-dimensional and discontinuous with the identity transformation.

In some embodiments, the posterior q_{ψ}_{ₓ}(z|x) may be calculated as the product of factors of each of these high-dimensional variables, i.e. q_{ψ}(z|x)∝Πᵢƒᵢ(zᵢ|z, ψₓ)

The posterior may be parameterized in such a way that it does not exactly match the true posterior distribution, i.e. that it is not conjugate to p_{θ}(x, z)—in such a case the parameters of the recognition model may be optimized variationally to minimize a divergence to or from the true posterior distribution.

In some embodiments, p_{θ}(x, z) is constructed by lifting each of the latent variables zᵢ into a higher-dimensional space, such that zᵢ∈ [symbol] ^{N}, and constructing the probability function p_{θ}(x, z) by interactions between them. This PGM may of course equivalently be described as one with additional constraints or interactions between them to enforce the smoothness required to optimize eqn. 2 (e.g. by enforcing that particular sets of single-dimensional variables have a fixed 12-norm); as it is one of the simplest methods to smooth the functions, for ease of discussion in the following we will consider each zᵢ∈ [symbol] ^{N} to be a single hyper-dimensional latent variable, rather than a collection of lower-dimensional variables with such a constraint between them.

There are clear tradeoffs in selection of the dimensionality of the latent variables. Larger values for N typically improve the smoothness of the optimization, but come at increased computational cost, hence slower training and inference. In many embodiments, selecting the dimensionality such that N≈\sqrt{width}, where width is the maximum number of interactions involving a single latent variable, provides a good balance between the tradeoffs.

The function p_{θ}(x, z) may be defined such that it obeys rotational symmetry about the origin, I.e. that interactions between variables are invariant under transformations T in SO(N). In some embodiments, p_{θ}(x, z) may be constructed by functions where the individual variables interact only through their relative directions and magnitudes.

In some embodiments, the latent variables are constrained to have unit length, ∥zᵢ∥=1, though any such restriction on magnitude is equivalent up to rescaling of the parameters θ. Additionally or alternately, the probability distribution of each variable may be parameterized by a set of weights Wᵢⱼ and (optionally) biases bᵢⱼ such that

$${p}_{θ} ( {z}_{i} ) ∝ exp ( 〈 {z}_{i} , {b}_{i} 〉 + {\sum }_{j} {W}_{ij} 〈 {z}_{i} , {z}_{j} 〉 ) \qquad ( 3 )$$

where [symbol] xᵢ, xⱼ [symbol] denotes an inner (dot) product between vectors xᵢ and xⱼ, and we use θ to refer to all trainable parameters of the model, i.e. {Wᵢⱼ, bᵢ}. Within such models, the latent variables take von Mises-Fisher (VMF) distributions, with parameters determined by their parents. We will in the following refer to this subset of embodiments—models with unit constrained, and linear (in energy) pairwise interactions as hyperspherical neural networks, and provide more detailed description of their construction and methods that allows their training without sampling from the posterior distribution. In many instances, calculation of optimization gradients without sampling is preferable as it reduces the variance of gradient estimates, though in cases where approximation is necessary there is a tradeoff with optimization accuracy.

Note that eqn. 3 uses zᵢ and refers specifically to the latent vectors, but the output nodes may have a similar formulation, though typically in a lower dimensional space N=1 or 2.

In some embodiments, the latent variables take on a conditional probability distribution according to a scaled gaussian, where

$$p ( {z}_{i} \vert {z}_{: i} ) = 𝒩 ( μ / a , I / a ) , μ = {Wz}_{: i} , a = N / 2 + \sqrt{{( N / 2 )}^{2} + {‖ μ ‖}_{2}^{2}}$$

This has similar moments and symmetry to the von-Mises Fisher distribution above, but has the benefit of being non-zero over [symbol] ^{N}, and so is compatible with multivariate gaussian variational posterior distributions. In this embodiment, the ELBO of the latent parameters is again invariant to rotations of the space.

In some embodiments, the interactions are restricted such that the system forms a directed acyclic graph (e.g. that Wᵢⱼ=0:i≥j in eq. 3). This restriction allows the direct sampling from the probability distribution, without requiring computationally more intensive Monte Carlo sampling methods. With such a restriction, we define the parents of a node i to be the nodes influencing its distribution, so for the case of Wᵢⱼ=0:i≥j, we can define the parents of node i as pa(i)={0, 1, . . . , i−1}.

In some embodiments, interactions are specified such that variables are arranged into sequential layers by disallowing interactions between variables in the same layer.

In some embodiments, parameters from θ are shared between multiple factors, e.g. to enforce translation equivariance in parts of the model similar to that imposed in convolutional neural networks.

In some embodiments, particularly those involving norm-constrained variables, the posterior may be specified such that it factorizes about each variable according to a von Mises-Fisher distribution, i.e. as q(zᵢ|x)∝exp(κᵢμᵢzᵢ)

In some embodiments, the variational posterior is conditioned on the value of parent variables, i.e. q_{ψ}(zᵢ|z_{:i}, x). In many preferred embodiments, the form of the conditional variational posterior is similar to that of the probability function p. For example, in the case of a scaled gaussian probability function, the variational posterior may be

$${q}_{ψ} ( {z}_{i} \vert {z}_{: i} ) = 𝒩 ( \frac{μ}{a} , \frac{I}{a} ) , μ = {Wz}_{: i} + {ψ}_{i} , a = N / 2 + \sqrt{{( N / 2 )}^{2} + {‖ μ ‖}_{2}^{2}}$$

In some embodiments, the variational parameters also modify the gaussian covariance matrix. In some embodiments, the form of the covariance may be structured so as to reduce computational, communication, and/or storage costs.

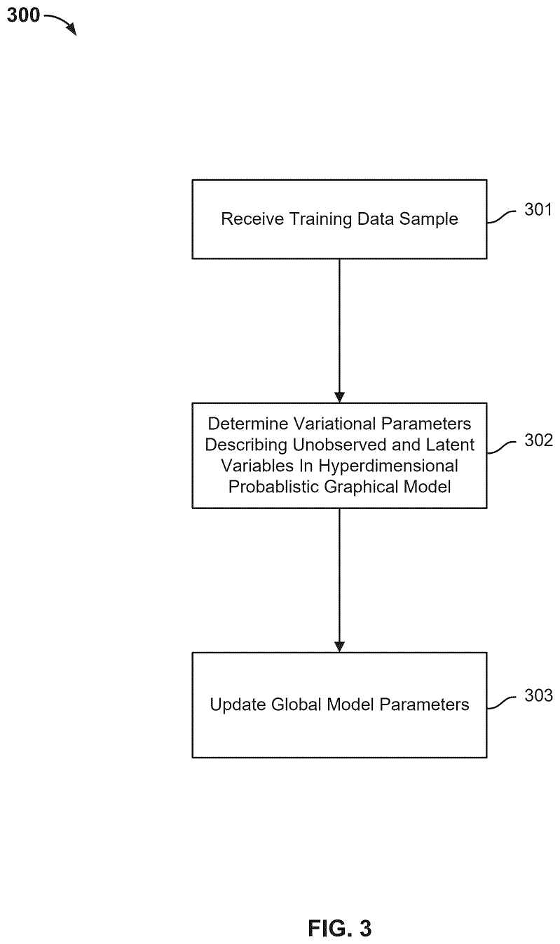

The model may be trained to maximize the log-likelihood of the data, in some embodiments through mini batch or batch gradient descent. FIG. 3 shows a flow diagram schematic for an example training procedure for determining the weights of a hyperdimensional graphical model in accordance with some embodiments. It shows the steps for training based on a single data point at a time, but it may also be trained batch-wise or through other methods. The system receives a training data point (step 301), which specifies the value over all or a subset of variables 101. It then finds variational parameters specifying q(z|x) to optimize the ELBO or surrogate objective (step 302). The system then updates the global parameters θ to maximize the ELBO or surrogate objective (step 303).

While this process of ELBO optimization appears similar to that used in Variational Autoencoders, the described specification differs significantly in that instead of using a second neural network to determine q_{φ}(z|x) the procedure described here uses an optimization routine to find q(z|x) for each data point x.

The update in step 303 may be carried out via a variety of methods, including using gradient descent, stochastic gradient descent, or one of the many well-known neural-network optimization routines (e.g. Adam, RMSprop, Lion, etc.), or through methods such as variational expectation maximization, or techniques employing noisy estimates of the gradients with respect to θ and φ.

In other embodiments, the model may be trained or pre-trained layer-wise, with techniques such as contrastive divergence.

Some embodiments include an augmenting neural-network based recognition model q_{φ}(z|x) to seed starting values for the optimization routine or as estimates of q_{ψ}_{ₓ}(z|x). This has benefits over traditional structured variational auto encoders in that the training signal for learning q_{φ}(z|x) is more informative, as it is directly finding the optimum q_{ψ}_{ₓ}(z|x) rather than indirectly by back-propagation through the ELBO or other objective.

Given a generative model architecture and method for computing q(z|x), it is possible to extend the capability of the system to other machine learning tasks relying on conditioning or marginalization of the graphical model, including classification or inpainting. For example, by considering one or a set of the latent variables as denoting class membership, the probability distribution over this set, conditional on the data x can be used to classify the data; similarly, the distribution over latent variables conditional on a partially observed data point implies a probability distribution over the missing data. By providing a direct estimate of p(x), the system is also trivially able to detect anomalies as data points with low likelihood under the model.

Because hyperspherical and hyperdimensional networks can determine the posterior parameters ψₓ via an optimization process rather than a feedforward network, they are more easily able to handle missing data. Reconfiguring the system to perform posterior predictions conditioned on a different subset of data components, or marginalization of predictions over a subset of components, may be performed with the same learned model parameters θ. This is in contrast to variational autoencoders, where the recognition model is trained specifically for such tasks. Hence, in some embodiments, training data points may be missing some components of x, and in other embodiments, the trained model parameters θ may be used to determine probability distributions over missing data components, such as for inpainting or classification tasks.

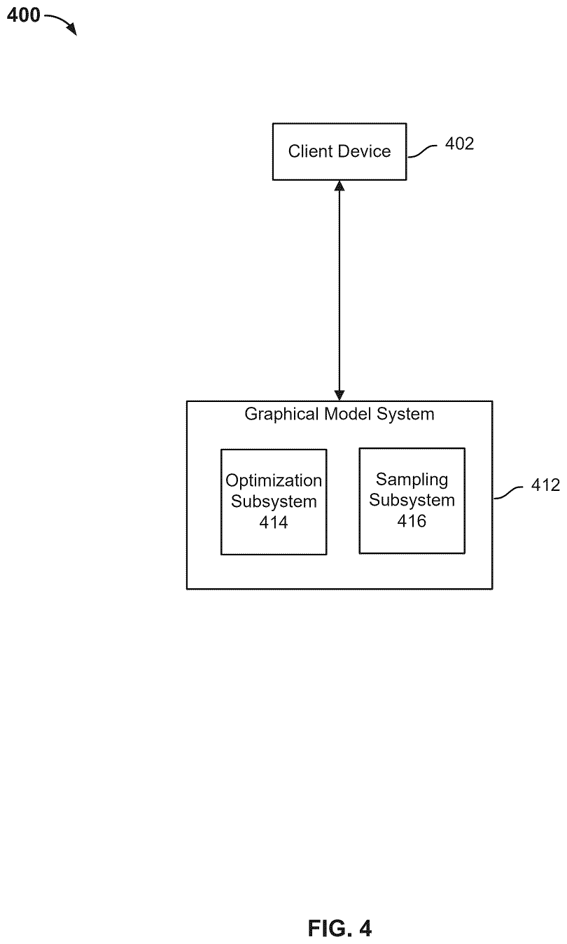

FIG. 4 is a block diagram illustrating a system to generate output samples conditioned on partial inputs using a probabilistic graphical model in accordance with some embodiments. In the example shown, system 400 includes a client device 402 configured to transmit input data and a graphical model system 412 configured to generate one or more output samples conditioned on the received input data.

In some embodiments, system 400 is configured for machine translation, in which the input data provided by client device 402 comprises a sequence of tokens in a source language, and graphical model system 412 generates a corresponding sequence of tokens in a target language conditioned on the input sequence.

In some embodiments, graphical model system 412 is configured for speech recognition or speech generation. In such embodiments, the input provided by client device 402 includes audio features representing spoken content, textual tokens representing linguistic content, or a combination thereof. When configured for speech recognition, graphical model system 412 generates a sequence of textual tokens conditioned on input audio features. When configured for speech generation, graphical model system 412 generates audio features or synthesized audio conditioned on an input sequence of textual tokens.

In some embodiments, graphical model system 412 is configured for image recognition or image generation. In such embodiments, input received from client device 402 includes pixel data representing an image, textual or symbolic descriptions of the contents of an image, labels indicating object locations or classifications, or partial versions of any such data. When configured for image generation, graphical model system 412 generates a complete image conditioned on a textual description, a detection map, or other semantic information. When configured for image recognition or captioning, graphical model system 412 generates textual or semantic information describing the contents of an input image. In some embodiments, system 400 receives a partially specified image and generates one or more samples completing the missing regions of the image.

In some embodiments, graphical model system 412 is configured for time-series modeling, including applications involving missing, noisy, or irregularly sampled input data. For example, system 400 may estimate or predict financial indicators, sensor readings, medical measurements, environmental data, or other temporal sequences. In such embodiments, system 400 generates predicted or imputed values for absent or future time-series elements by producing samples or distributions conditioned on the observed portions of the input sequence, using a sample generation process such as process 200 described herein.

In some embodiments, graphical model system 412 is configured for language modeling or conversational interaction, including generation of text continuations, dialogue responses, or extended sequences of texts or media conditioned on one or more input tokens or prompts provided by client device 402. In some embodiments, system 400 generates predicted next tokens, complete message responses, or multi-modal outputs without requiring retraining of the underlying probabilistic graphical model when different subsets of input variables are specified.

In some embodiments, graphical model system 412 is configured as a recommendation engine, trained using historical user-interaction information, preference data, or other contextual signals. In such embodiments, system 400 generates affinity scores, rankings, or probability distributions representing expected user responses to candidate items, conditioned on available input information.

In some embodiments, graphical model system 412 is configured for outlier or anomaly detection. For example, system 400 may be trained using representative samples of normal or typical data, and may generate an anomaly score, likelihood estimate, or other measure indicating whether an input sample is consistent with the learned data distribution. In some embodiments, such output may be derived from a conditional or joint probability with the input data, enabling detection of rare or atypical patterns without requiring retraining when different subsets of input features are observed.

In some embodiments, system 400 is configured as an unsupervised embedding system, in which high-dimensional input variables are mapped to lower-dimensional latent representations, and output samples are generated conditioned on partial observations in either space.

Graphical model system 412 includes optimization subsystem 414. The optimization subsystem determines values of variational parameters ψ̅ by function optimization. In some embodiments, the optimization is of the marginalized probability over the unobserved variables in set D, i.e. the indices of variables not specified in \tilde{x}, i.e. maximum likelihood variational inference.

$$\overline{ψ} = {max}_{ψ} {\int }_{i ∉ D} P ( x \vert ψ ) d {x}_{i}$$

In particular, hyperdimensional PGMs allow scaling of latent-variable models to high-dimensional structured latent spaces using a specific form of p_{θ}(x, z) so that the posterior distribution q_{ψ}_{ₓ}(z|x) or a variational approximation to it may be determined more efficiently by optimization of the marginalized likelihood p_{θ}(x) or surrogate objective. This optimization may be performed by gradient descent, Gibbs sampling, or any other method. This optimization does not need to find the global minimum or converge exactly to a local minimum—approximate solutions are sufficient in many embodiments.

Graphical model system 412 includes sampling subsystem 416 configured to determine one or more output samples using variational parameters determined by optimization subsystem 414.

In some embodiments, graphical model system 412 forms a directed acyclic graph, a neural network system of sampling subsystem 416 iteratively constructs output data sample by determining a set of variational parameters from the optimization subsystem 414, and sampling a value for each position xᵢ. In some embodiments, the optimization subsystem 414 is used to determine a new set of variational (sampling) parameters at intervals between such sampling steps.

In some embodiments, sampling subsystem 416 implements a Monte Carlo sampling algorithm to produce a sample from the learned (directed or undirected) graphical model, and then convert it from the embedding space back to the application space.

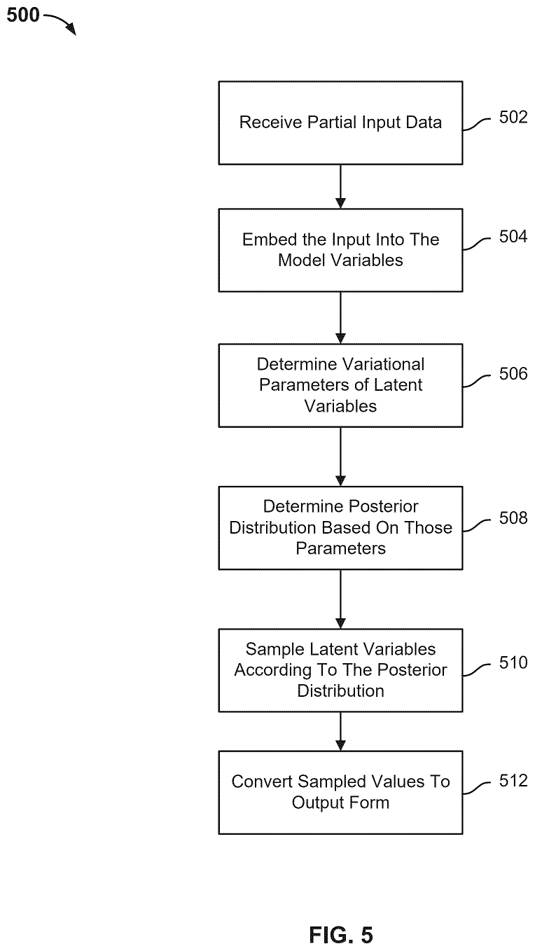

FIG. 5 is a flow diagram illustrating a process to generate output samples conditioned on partially specified input data using a probabilistic graphical model in accordance with some embodiments.

At 502, partial input data is received. In some embodiments, the partial input data corresponds to an image in which a subset of pixel values is specified. In some embodiments, the partial input data corresponds to time-series values such as financial indicators or sensor measurements. In some embodiments, the partial input data corresponds to a sequence of word or sentence tokens. In some embodiments, the partial input data corresponds to conversational input associated with a dialogue system.

The partial input data may correspond to a subset of observable variables corresponding to known components of a data sample. For example, the input may include a portion of an image, a sequence of text tokens, audio features, or other observed data elements while other components remain unspecified. The set of variables provided as conditioning input is arbitrary and can vary between data points during both training and inference. In some embodiments, these observed variables correspond to the set of conditioning variables 103, which may be selected from either observable variables 101 or latent variables 102, depending on the application.

Optionally, output generation may be further conditioned on contextual input, prior outputs, or intermediate predictions.

At 504, the input is embedded into the model variables such that the observed values become part of the PGM's variable space. For example, a hyperdimensional generative model may be configured to randomly sample images from a learned distribution, to infer unobserved pixel values for image inpainting, to generate media conditioned on a prompt, or to determine a classification by producing a probability distribution over candidate labels.

The embedding may employ any suitable representation, including pixel intensities, text tokens, audio features, or intermediate representations such as principal-component embeddings or neural-network-derived embeddings. By incorporating observed information directly into the variable structure of the probabilistic graphical model, the system conditions the distribution of remaining variables, including latent variables, on the supplied values. In some embodiments, the embedding step designates the embedded values as conditioning variables, and the particular subset used for conditioning may differ for each data instance.

At 506, variational parameters associated with one or more latent variables are determined by optimizing a probabilistic objective reflecting the likelihood of the observed data under the learned model. In some embodiments, the variational parameters are obtained by maximizing a marginalized likelihood or evidence lower bound (ELBO) over unobserved components of the data. Unlike approaches that rely on a separate recognition network to approximate posterior distributions, the disclosed embodiments determine variational parameters directly through optimization over latent-variable distributions within the graphical model itself. In some embodiments, the optimization exploits structural or symmetry properties of the latent interaction space, enabling scalable approximation of posterior distributions. The variational distribution may, for example, approximate a von Mises-Fisher distribution or another factorized distribution suitable for efficient inference and sampling.

In various embodiments, the quality of estimates of posterior distribution over latent variables is improved, thus ultimately improving the quality of generated samples as well as predictions of classification or missing data.

At 508, posterior distribution is determined based on the variational parameters obtained from the optimization process. The posterior distribution represents a conditional probability distribution of the latent variables given the observed input data, the selected conditioning variables, and the structure of the probabilistic graphical model. This posterior distribution characterizes uncertainty over unobserved variables and provides a probabilistic basis for generating samples that are consistent with the partially specified input.

At 510, the latent variables are sampled according to the posterior distribution. In some embodiments, sampling is performed sequentially or iteratively in an order consistent with dependencies defined by the probabilistic graphical model, such as a directed acyclic graph structure. The sampled latent variable values are selected such that they are statistically consistent with the observed input data and reflect uncertainty associated with unobserved portions of the data.

At 512, the sampled values are converted to output form corresponding to an application domain. This conversion may include decoding latent representations into pixel values, text tokens, audio signals, class labels, or other domain-specific outputs. The resulting output sample is consistent with the observed input data and reflects the probabilistic structure learned by the graphical model.

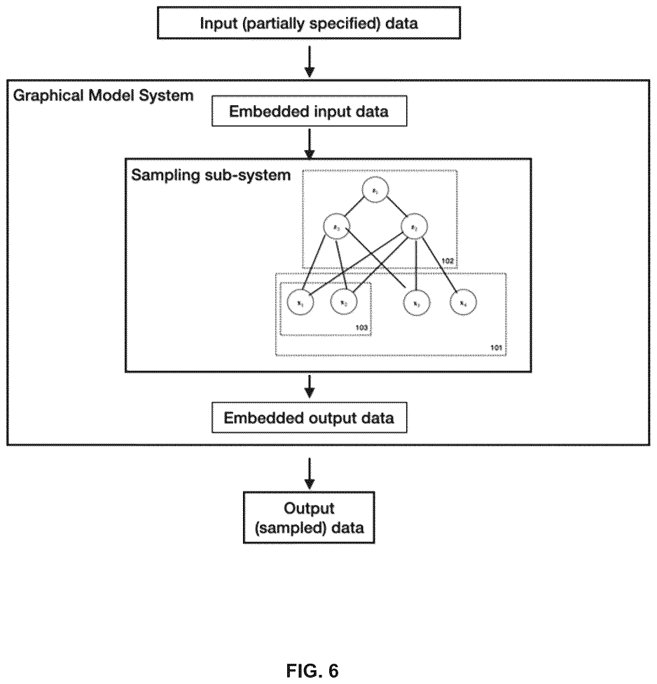

FIG. 6 illustrates an example data flow within a graphical model system configured to generate output data samples conditioned on partially specified input data, in accordance with some embodiments.

As shown, input data is received in a partially specified form, such that values are provided for only a subset of variables associated with a data sample. The input data is embedded into a variable space of the graphical model to produce embedded input data, which represents the observed components of the data sample within the probabilistic graphical model.

The embedded input data is provided to a sampling subsystem of the graphical model system. The sampling subsystem includes a probabilistic graphical model comprising a plurality of observable variables and latent variables arranged according to a dependency structure, such as a directed acyclic graph. In the illustrated example, a subset of variables (e.g., conditioning variables 103) corresponds to observed or fixed values derived from the embedded input data, while remaining variables (e.g., latent variables 102 and observable variables 101) are unobserved and subject to inference and sampling.

Using variational parameters determined by an optimization subsystem (not shown), the sampling subsystem samples values for latent variables and, optionally, additional observable variables in an order consistent with the dependency structure of the graphical model. Sampling is performed such that the generated values are statistically consistent with the observed embedded input data and the learned joint distribution encoded by the graphical model.

The sampled variable values are combined with the embedded input data to form embedded output data, representing a completed or inferred version of the data sample within the embedding space of the model. The embedded output data is subsequently converted into output (sampled) data in an application-specific form, such as an image, sequence of tokens, audio signal, time-series values, or other structured output. The resulting output sample is consistent with the partially specified input data and reflects one realization drawn from the conditional distribution defined by the graphical model.

### Hyperspherical Network Computations

Many of the quantities described above required for training and sampling from hyperspherical networks do not have obvious, computationally tractable procedures for their calculations, so we describe some here:

### Sampling

For the particular case of exponential interactions with unit-normal, independent, latent variables, the form of the probability distribution of each variable is equivalent to a von Mises-Fisher distribution with mean direction u; and concentration parameter κᵢ≥0.

$$p ( {z}_{i} ) = {C}_{d} ( {κ}_{i} ) exp ( {κ}_{i} {μ}_{i}^{τ} {z}_{i} ) \qquad ( 2 )$$

$$Where$$

$${C}_{d} ( κ ) = \frac{{κ}^{d / 2 - 1}}{{( 2 π )}^{d / 2} {I}_{d / 2 - 1} ( κ )} , ‖ μ ‖ = 1$$

and where Iᵥ is the modified Bessel function of the first kind of order v.

The von Mises-Fisher parameters κᵢμᵢ may be obtained from each node's parents:

$${κ}_{i} {μ}_{i} = {b}_{i} + {\sum }_{j ∈ p a ( i )} {z}_{j} {W}_{ij}$$

For directed acyclic graphical models, samples may be obtained by a hierarchical sampling procedure, starting at the root node and sampling each variable. For models containing loops, sampling is repeated until the system reaches equilibrium. This may be, for example, by Gibbs sampling.

Sampling from eqn. 2 may be done, for example, according to the procedure outlined in “Fast Python sampler for the von Mises Fisher Distribution” by Pinzon et al.

### Approximation of the ELBO

The ELBO may be broken down into a Kullback-Leibler divergence term of the variational distribution q from the one imposed by its parents, and the data log likelihood conditional on the variational distribution. These terms may be estimated separately.

$${𝔼}_{z ∼ {q}_{{ψ}_{x}} ( z \vert x )} [ log ( \frac{{p}_{θ} ( x , z )}{{q}_{ϕ} ( z \vert x )} ) ] = {𝔼}_{z ∼ {q}_{{ψ}_{x}} ( z \vert x )} [ log ( \frac{{p}_{θ} ( z )}{{q}_{{ψ}_{x}} ( z \vert x )} ) ] + {𝔼}_{z ∼ {q}_{{ψ}_{x}} ( z \vert x )} [ log ( {p}_{θ} ( x \vert z ) ) ] = - {D}_{KL} ( {q}_{{ψ}_{x}} ‖ {p}_{θ} ) + {𝔼}_{z ∼ {q}_{{ψ}_{x}} ( z \vert x )} [ log ( {p}_{θ} ( x \vert z ) ) ]$$

### KL Divergence

$${D}_{KL} ( {q}_{{ψ}_{x}} ‖ {p}_{θ} ) = {\int }_{z} {q}_{{ψ}_{x}} ( z ) log {q}_{{ψ}_{x}} ( z ) d z - {\int }_{z} {q}_{{ψ}_{x}} ( z ) log {p}_{θ} ( z ) d z$$

The first term is relatively simple to compute in the mean-field setting, as it is simply the von Mises-Fisher entropy

$${\int }_{z} {q}_{{ψ}_{x}} ( z ) log {q}_{{ψ}_{x}} ( z ) dz = {〈 log {f}_{d} ( x ; μ , κ ) 〉}_{x ∼ VMF ( μ , κ )} = log {C}_{d} ( κ ) + κ {A}_{d} ( κ )$$

$${A}_{d} ( κ ) = \frac{{I}_{d / 2} ( κ )}{{I}_{d / 2 - 1} ( κ )}$$

The second term is somewhat more involved, with calculation of p_{θ}(zᵢ) requiring marginalization of the node's parents:

$${p}_{θ} ( {z}_{i} ) = \frac{1}{{𝒵}_{i}} {\int }_{{z}_{j}} {\prod }_{j} [ q ( {z}_{j} ) ] exp ( {\sum }_{i \neq j} {W}_{i j} 〈 {z}_{i} , {z}_{j} 〉 ) {dz}_{j}$$

In some embodiments, the variational distribution is a von Mises-Fisher distribution, so

$$p ( {z}_{i} ) = \frac{1}{{𝒵}_{i}} \int {\prod }_{j} [ {C}_{d} ( {κ}_{j} ) exp ( {κ}_{j} {μ}_{j}^{T} {z}_{j} + {W}_{i j} {z}_{j}^{T} {z}_{i} ) ] {dz}_{0} … {dz}_{j}$$

Grouping terms containing z₀ into a separate integral yields

$$= \frac{1}{{z}_{i}} [ \int {\prod }_{j ∈ 1 ¨ j} [ {C}_{d} ( {κ}_{j} ) exp ( {κ}_{j} {μ}_{j}^{T} {z}_{j} + {W}_{ij} {z}_{j}^{T} {z}_{i} ) ] {dz}_{1} … {dz}_{j} ] [ \int {C}_{d} ( {κ}_{0} ) exp ( {κ}_{0} {μ}_{0}^{T} {z}_{0} + {W}_{i 0} {z}_{0}^{T} {z}_{i} ) {dz}_{0} ]$$

And by similarity to the von Mises-Fisher distribution noting that the last term integrates to a concentration parameter

$$\begin{matrix}= \frac{1}{{z}_{i}} [ \int {\prod }_{j ∈ 1 ¨ j} [ {C}_{d} ( {κ}_{j} ) exp ( {κ}_{j} {μ}_{j}^{T} {z}_{j} + {W}_{ij} {z}_{j}^{T} {z}_{i} ) ] {dz}_{1} … {dz}_{j} ] [ {C}_{d} ( {κ}_{0} ) / {C}_{d} ( ‖ {κ}_{0} {μ}_{0} + {W}_{i 0} {z}_{i} ‖ ) ] \\ = \frac{1}{{𝒵}_{i}} {\prod }_{j} [ {C}_{d} ( {κ}_{j} ) / {C}_{d} ( ‖ {κ}_{j} {μ}_{j} + {W}_{ij} {z}_{i} ‖ )\end{matrix}$$

We can further approximate the log of the normalization constant by a quadratic, i.e.

$$1 / {C}_{d} ( ‖ {κ}_{j} {μ}_{j} + {W}_{ij} {z}_{i} ‖ ) = exp ( {γ}_{j}^{T} {z}_{i} + {z}_{i}^{T} {A}_{j} {z}_{i} ) ,$$

obtaining

$$\approx \frac{1}{{z}_{i}} {\prod }_{j} [ {C}_{d} ( {κ}_{j} ) exp ( {γ}_{j}^{T} {z}_{i} + {z}_{i}^{T} {A}_{j} {z}_{i} ) ] {dz}_{i}$$

So finally (with the C_{d}(κⱼ) terms dropped as they do not depend on z)

$$\begin{matrix}log {p}_{θ} ( {z}_{i} ) \approx {γ}^{T} {z}_{i} + {z}_{i}^{T} {Az}_{i} - log {𝒵}_{i} \\ Where γ = {\sum }_{j} {γ}_{j} and A = {\sum }_{j} {A}_{j}\end{matrix}$$

Noting the axial symmetry about each μⱼ, γⱼ and Aⱼ may be obtained from a 3-point quadratic fit to C_{d}(∥κⱼμⱼ+Wᵢⱼzᵢ∥) evaluated at (for example) zᵢ=μj, zᵢ⊥μj, zᵢ=−μⱼ.

The normalization constant [symbol] ᵢ may be estimated numerically with Monte Carlo simulation or by integration of the quadratic approximation.

$${𝒵}_{i} = {\int }_{{z}_{i}} exp ( {γ}^{T} {z}_{i} + {z}_{i}^{T} {Az}_{i} ) {dz}_{i}$$

The integral is equivalent to the normalization constant of a Fisher-Bingham distribution, and can be calculated by a number of means, including numerical approximation or approximation by the saddle point method such as the ones described in “Saddlepoint Approximations for the Bingham and Fisher-Bingham Normalising Constants” by Kume et al.

$$\begin{matrix}{c}_{1} ( λ , γ ) = {2}^{1 / 2} {{π}^{( d - 1 ) / 2} ( {K}_{θ}^{( 2 )} )}^{- 1 / 2} \{ {\prod }_{i = 1}^{d} {( {λ}_{i} - t )}^{- 1 / 2} \} exp ( - t + \frac{1}{4} {\sum }_{i = 1}^{d} \frac{{γ}_{i}^{2}}{{λ}_{i} - t} ) \\ {c}_{2} ( λ , γ ) = {c}_{1} ( λ , γ ) ( 1 + T ) , {c}_{3} ( λ , γ ) = {c}_{1} ( λ , γ ) exp ( T )\end{matrix}$$

Where λ are the eigenvalues of A and γ is replaced by Q^{T}γ (transforming the previously obtained γ into the space of A's eigenvectors) and the jth derivatives of the cumulant generating function for independent non central

$${χ}_{1}^{2}$$

is given by

$$\begin{matrix}{K}_{θ}^{( j )} ( t ) = {\sum }_{i = 1}^{d} \{ \frac{( j - 1 ) !}{2} \frac{1}{{( {λ}_{i} - t )}^{j}} + \frac{j !}{4} \frac{{γ}_{i}^{2}}{{( {λ}_{i} - t )}^{j + 1}} \} \\ T = \frac{1}{8} {ρ}_{4} - \frac{5}{24} {ρ}_{3}^{2} \\ {ρ}_{j} = {K}_{θ}^{( j )} / {( {K}_{θ}^{( 2 )} )}^{j / 2}\end{matrix}$$

Where t is the solution in (−∞, λ₁) to the equation

$${K}_{θ}^{( 1 )} ( t ) = 1.$$

This may be determined by any number of numerical methods.

The final integration over zᵢ may be estimated using, for example, a sampling method.

Alternately, the second term in the KL divergence may be estimated for VMF-distributed posteriors by

$$\begin{matrix}{\int }_{z} {q}_{{ψ}_{x}} ( z ) log {p}_{θ} ( z ) dz = {( {A}_{d} ( {κ}_{i} ) {μ}_{i} )}^{T} {μ}_{p} + log {C}_{d} ( \sqrt{{‖ {μ}_{p} ‖}^{2} + s} ) \\ s = {\sum }_{j} ( 1 - {A}_{d} ( {κ}_{j} ) ) {W}_{ji}^{2} and {μ}_{p} = {\sum }_{j} ( {A}_{d} ( {κ}_{j} ) {μ}_{j} {W}_{ji} )\end{matrix}$$

This can be derived by estimating the expected value of the concentration parameter by calculating the concentration parameter for the expected value of K, and tends to have reasonable performance while being much faster than the previous method.

### Data Log-Likelihood

Typically, the training data for a neural network will not consist of a set of unit-length variables in [symbol] ^{N}, but will usually be of lower dimension (often either binary as in the case of black-and-white images or single dimensional, as in the case of grayscale images). In this case, we reduce the dimensionality of the output variables.

As before, the data log-likelihood term [symbol] _{z~q(z|x)}[log p(x|z)] may be approximated by Monte Carlo estimation, but it is computationally cheaper to obtain gradients for the internal optimization routine with a closed-form solution. One such approach is to use a gaussian approximation for the parents.

$${𝔼}_{z ∼ q ( z \vert x )} [ log ( p ( {x}_{i} \vert z ) ) ] = {\int }_{Z} q ( z ) σ ( {x}_{i} {\sum }_{j} {W}_{ij} {z}_{j} ) dz$$

This integral is over all parents z, and is generally computationally intractable. Approximating each parent by a Gaussian distribution with mean and standard deviation calculated from its underlying von Mises-Fisher distribution allows replacing the integral over all parents with one over a single normal distribution (computed via a sum of the parent normal distributions) which may, for the case of binarized outputs, be further reduced to a single dimension and estimated by a probit function.

$$= {\int }_{{ℝ}^{N}} 𝒩 ( {\sum }_{j} {μ}_{j} , {\sum }_{j} {v}_{j} ) σ ( {x}_{i} z {\sum }_{j} {W}_{ij} ) dz$$

Where [symbol] is a gaussian distribution obtained from the weighted sum of the parent distributions z approximated by a gaussian distribution and projected onto xᵢ, μ and v the mean and covariance of that projection, and φ the probit function.

This probit function estimate ignores correlations between output elements. While it often produces adequate results for systems with independent variational posterior distributions, better results can be obtained using importance sampling estimates, or other algorithms for calculating multivariate normal orthant probabilities.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
embedding partial input data corresponding to a subset of variables of a data sample into a variable space of a probabilistic graphical model containing a plurality of transformation invariant components;
determining variational parameters associated with one or more latent variables of the probabilistic graphical model by optimizing a probabilistic objective reflecting likelihood of the partial input data by adjusting variational parameters governing the probability distribution over latent variables in the probabilistic graphical model;
sampling latent variable values from a posterior distribution defined by the variational parameters; and
generating output data by converting the sampled latent variables into output data corresponding to an application domain.

2. The method of claim 1, further comprising receiving the partial input data.

3. The method of claim 1, wherein remaining variables of the data sample are unspecified and the subset of variables is designated as conditioning variables.

4. The method of claim 1, wherein the sampling is performed in accordance with dependencies of the probabilistic graphical model.

5. The method of claim 1, wherein the output data is statistically consistent with the partial input data without retraining model parameters of the probabilistic graphical model.

6. The method of claim 1, wherein the partial input data corresponds to an image in which a subset of pixel values is specified, time-series data, a sequence of word or sentence tokens or conversational input associated with a dialogue system.

7. The method of claim 1, wherein the variational parameters are obtained by maximizing a marginalized likelihood or evidence lower bound over unobserved components of the partial input data.

8. The method of claim 1, further comprising determining the posterior distribution.

9. The method of claim 8, wherein the posterior distribution represents a conditional probability distribution of the one or more latent variables given observed portions of the partial input data, selected conditioning variables, and a structure of the probabilistic graphical model.

10. The method of claim 1, wherein the sampling is performed sequentially or iteratively in an order consistent with dependencies defined by the probabilistic graphical model.

11. The method of claim 1, wherein the sampled latent variable values are selected to be statistically consistent with the observed portions of the partial input data and reflect uncertainty associated with unobserved portions of the partial input data

12. The method of claim 1, wherein generating the output data comprises generating one or more of: image data, text data, audio data, time-series data, classification outputs, or recommendation outputs.

13. The method of claim 1, wherein sampling the latent variable values comprises performing Monte Carlo sampling from the posterior distribution.

14. The method of claim 1, wherein embedding the partial input data comprises mapping observed input values to corresponding nodes of the probabilistic graphical model while leaving other nodes unassigned.

15. A system, comprising:
a processor configured to:
embed partial input data corresponding to a subset of variables of a data sample into a variable space of a probabilistic graphical model containing a plurality of transformation invariant components;
determine variational parameters associated with one or more latent variables of the probabilistic graphical model by optimizing a probabilistic objective reflecting likelihood of the partial input data by adjusting variational parameters governing the probability distribution over latent variables in the probabilistic graphical model;
sample latent variable values from a posterior distribution defined by the variational parameters; and
generate output data by converting the sampled latent variables into output data corresponding to an application domain; and
a memory coupled to the processor and configured to provide the processor with instructions.

16. The system of claim 15, wherein remaining variables of the data sample are unspecified and the subset of variables is designated as conditioning variables.

17. The system of claim 15, wherein the partial input data corresponds to an image in which a subset of pixel values is specified, time-series data, a sequence of word or sentence tokens or conversational input associated with a dialogue system.

18. The system of claim 15, wherein the processor is configured to perform the sampling sequentially or iteratively in an order consistent with dependencies defined by the probabilistic graphical model.

19. The system of claim 15, wherein to generate the output data, the processor is further configured to generate one or more of: image data, text data, audio data, time-series data, classification outputs, or recommendation outputs.

20. A computer program product embodied in a non-transitory computer readable medium and comprising computer instructions for:
embedding partial input data corresponding to a subset of variables of a data sample into a variable space of a probabilistic graphical model containing a plurality of transformation invariant components;
determining variational parameters associated with one or more latent variables of the probabilistic graphical model by optimizing a probabilistic objective reflecting likelihood of the partial input data by adjusting variational parameters governing the probability distribution over latent variables in the probabilistic graphical model;
sampling latent variable values from a posterior distribution defined by the variational parameters; and
generating output data by converting the sampled latent variables into output data corresponding to an application domain.
